(19) United States
(12) Patent Application Publication
(10) Pub. No.: US 2006/0121962 A1
(43) Pub. Date: Jun. 8, 2006

(54) CARRYING CASE FOR A MOBILE TELEPHONE WITH CORD ORGANIZATION MEANS

(76) Inventor: Paramjit Kohli, Cranbourne (AU)

Correspondence Address: BLUMENFELD, KAPLAN & SANDWEISS, P.C., 168 NORTH MERAMEC, 4TH FLOOR, CLAYTON, MO, 63105-3763, US

(21) Appl. No.: 10/904,932

(22) Filed: Dec. 6, 2004

(51) Int. Cl. H04M 1/00

(52) U.S. Cl. 455/575.8; 455/575.1

(57) ABSTRACT

A carrying case for a mobile telephone is shown which includes organization means for a corded headset. The organization means comprise two prongs extending from the case in opposite directions, and a tying strap. The cord from a headset plugged into the telephone can be wrapped around the prongs without unplugging the headset, and the strap closed around the wound cord to prevent unwinding.

### BACKGROUND OF THE INVENTION

1. Field of the Invention

The present invention relates to a case for a mobile telephone, and more particularly to one with means for storing a cord in an organized manner.

2. Description of the Prior Art

It is unquestioned that mobile telephones have become extremely prevalent in modern society. It has become extremely important to stay in communication with others, regardless of where one might be. The reduced expense and reduced size of mobile telephones in recent years has only furthered the prevalence of these devices.

However, as mobile telephones have become more prevalent, problems have arisen. One of those problems has been the danger of talking on the telephone while driving. To overcome this problem, most mobile telephones come equipped with an adapter jack for a hands-free headset, which can be worn in the user's ear, leaving his or her hands free for driving or other tasks. The headsets have become extremely popular simply as a matter of convenience, even for non-drivers.

Most headsets are corded—meaning the audio signals between the mobile telephone and the headset are transmitted over a cord (usually a pair of conduit wires in a single outer insulating sheath). The cords can be unwieldy at times, becoming knotted and/or tangled. Usually the user must disconnect the headset when not in use, because there is no where to store the device while it is plugged into the mobile telephone.

One solution has been to use wireless headsets, which transmit radio frequency (RF) signals between the headset and telephone, thus eliminating the cord. Wireless technology is still very expensive however. A wireless headset for a mobile telephone may cost upward twenty times the cost of a corded headset.

Others have attempted, without success, to implement methods of storing the cord while it is connected to the telephone. U.S. Pat. No. 6,698,560 to Reardon et al. discloses a few such possibilities, including a pair of prongs that are affixed to an “appliance” (mobile telephone) around which the cord can be wrapped. Once attached however, the device permanently becomes part of the telephone, detracting from its ability to be stored in a minimum amount of space, and further providing something which could get snagged on something else when attempting to remove it from a pocket, or purse, etc. An alternative disclosed by Reardon is to provide a recess in the housing of the mobile telephone from which the same sort of prongs could be extended. This solution could not be retrofitted on existing telephones, and would significantly increase the complexity of manufacturing the mobile telephone.

U.S. Pat. No. 5,388,155 to Smith discloses, in one embodiment, a case for a cordless conventional (land-line) telephone that includes a fabric loop for temporarily tying the cord of a corded headset. It provides nothing, however, for winding/coiling the cord.

Thus, it is an object of the present invention to provide a convenient and simple device for storing the cord of a headset for a mobile telephone in an organized manner.

It is a further object of the present invention to provide such a device that can be retrofitted on to existing mobile telephones.

It is yet a further object of the present invention to provide such a device that can be easily removed from the mobile telephone.

### SUMMARY OF THE INVENTION

It was with the aforementioned objects in mind that the present invention was developed. The present invention combines means for storing a corded headset for a mobile telephone with a carrying case for the mobile telephone.

The carrying case is primarily similar to conventional carrying cases for mobile telephones, usually made of leather or similar material, and usually with some means for attaching to the wearer, such as by belt clip. Extending from one side of the case are two prongs around which a cord can be wrapped. In between the prongs is a fabric loop which can secure the cord in place once it is wrapped around the prongs.

The present invention may be combined with other features known to be usable on conventional mobile telephone carrying cases, such as a removable front, and an antenna loop strap.

### BRIEF DESCRIPTION OF THE DRAWINGS

These and further aspects and advantages of the invention will be discussed more in detail hereinafter with reference to the disclosure of the preferred embodiments, and in particular with reference to the appended Figures, wherein:

FIG. 1 is a front view of a carrying case for a mobile telephone embodying the present invention;

FIG. 2 is a perspective view of the carrying case of FIG. 1;

FIG. 3 is a front view of the carrying case of FIG. 1 with a mobile telephone and accompanying corded headset in place utilizing the storage means of the present invention;

FIG. 4 is side view of the carrying case, mobile telephone, and corded headset of FIG. 3; and

FIG. 5 is a perspective view of the carrying case, mobile telephone, and corded headset of FIG. 3.

### DETAILED DESCRIPTION OF THE PREFERRED EMBODIMENT

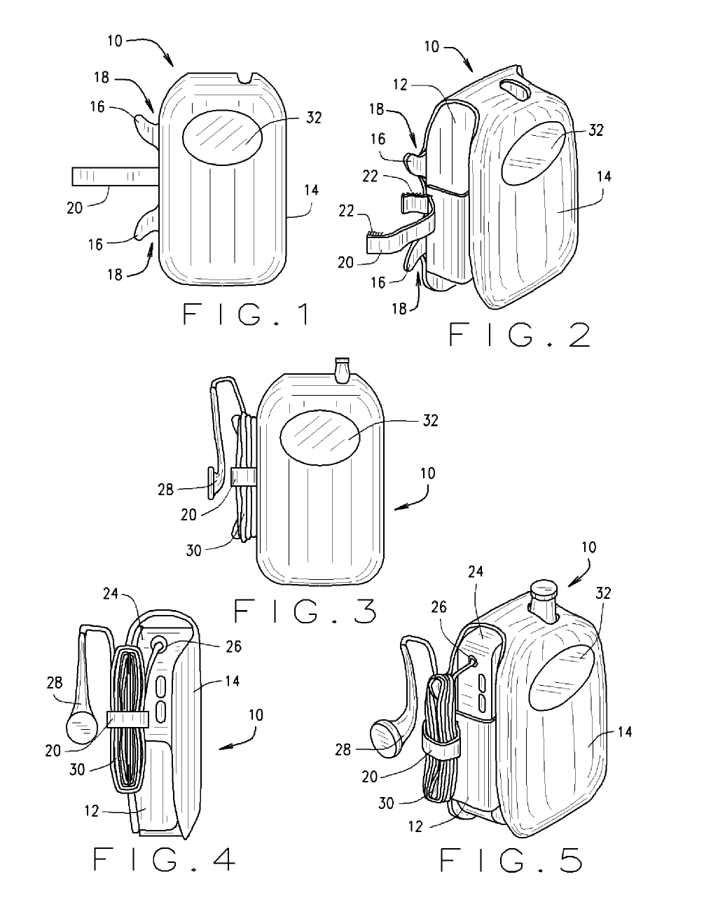

Referring now to FIGS. 1 and 2, a carrying case 10 embodying the present invention is shown generally. The case 10 may be designed for a folding-type mobile telephone (as shown) or for a non-folding-type mobile telephone. When designed for a folding-type mobile telephone, the case 10 has a base portion 12 and a front portion 14. The base and front portions 12, 14 may be integrated (as shown) or they may be separable parts. The organization means, which now be described in detail are attached to the base portion 12 of a case 10 designed for a folding-type mobile telephone.

The organization means comprise two prongs 16. The prongs 16 should extend in opposite directions. The prongs 16 may be straight and extend outwardly at an oblique angle, or they may be L-shaped and extend directly outward and subsequently bend 90° in opposite directions; or they may (as shown) be curved. Regardless of the specific shape and orientation of the prongs 16, they should each form a retention space 18 on the far side of each prong 16 in relation to the opposing prong 16.

The organization means further comprise a strap 20 extending from the side of the case 10 between the prongs 16. In the preferred embodiment (and as can be best seen in FIG. 2), the strap 20 is affixed to the case 10 at a point in between two ends of the strap 20 but significantly closer to one end, thereby creating two protrusions from case 10, one significantly shorter than the other. On either end of the strap 20 are corresponding closures 22. The closures 22 can be anything that permits quick and easy attachment of the strap ends to form a ring, such as a snap or a button. Several other alternatives for the form of the closures 22 will be readily apparent to someone of ordinary skill in the art. The inventor has found that the preferred form of the closures is corresponding hook and loop fasteners, such as Velcro® manufactured by Velcro USA, Inc. of Manchester, N.H. In such case, the corresponding closures 22 are located not only on opposite ends of the strap 20, but on opposite sides (faces) thereof.

Each case 10 is preferably manufactured to custom fit a particular model (or series of models) of mobile telephone 24. Therefore, the specific features of the case 10 and the specific location of the organization means will be dependent upon the design of the mobile telephone 24 that the case 10 is designed to fit. The drawings show the organization means on the left side of the case 10 because it was designed for a mobile telephone 24 with the headset jack 26 on the left side of the telephone. Most folding-type mobile telephones 24 have the headset jack 26 located in the base thereof. In the event that a case were designed specifically for a folding-type mobile telephone with the headset jack 26 in the upper portion of a folding-type mobile telephone 24, the organization means would likely be moved to the front portion 14 of the case 10.

Referring now to FIGS. 3-5, the invention is shown in use. A mobile telephone 24 is inserted into the case 10. A headset 28 (shown in the form of a simple ear bud) is attached to the mobile telephone 24 by a cord 30, which terminates in an adapter (not shown) plugged into the headset jack 26 of the mobile telephone 24. To keep the cord 30 organized, it is wrapped around the prongs 16 using the retention space 18. When the entire cord 30 is wound around the prongs 16, the strap 20 is closed (using the closures 22) to prevent the cord 30 from unwinding. When the user receives a telephone call, he or she simply opens the strap 20, unwinds a sufficient amount of slack in the cord 30 according to his or her personal preference, and puts on the headset 28 to answer the call. At the conclusion of the call, the process is repeated. The slack in cord is rewound around the prongs 16 and the strap 20 is once again closed.

The case 10 may be made of any material conventionally used in cases for mobile telephones, e.g. leather (natural or synthetic) or neoprene. The prongs 16 and strap 20 may be made of the same material as the case 10 itself. However, if the case 10 is made of leather and the prongs 16 are also made of leather, a stiffening insert, such as cardboard, should be sewn into the prongs 16 to maintain their shape and to prevent their collapse while being used. As an alternative, the prongs 16 may be made of a stiffer material than the case 10.

The case 10 may optionally include additional features found on conventional cases. The available features will naturally vary with the design of the mobile telephone 24 for which the case 10 is designed. Some available features include a window 32 in the front portion 14 of the case 10 to view information on a front screen of the mobile telephone 24; an antenna loop strap (not shown); or any of numerous types of belt clips (not shown) or an adapter for a belt clip, which can be sewn into the back panel of the base portion 12.

Although the preferred embodiment of the present invention has been disclosed for an illustrative purpose, those skilled in the art will appreciate that various modifications, additions and substitutions are possible without departing from the scope and spirit of the invention as disclosed in the accompanying claims which follow.

What is claimed is:

1. A carrying case for a mobile telephone, comprising:
a base portion adapted to hold a mobile telephone;
two prongs extending from said base portion;
a strap extending from said base portion at a position between said prongs; and
a closure on at least one end of said strap.

2. The carrying case of claim 1, wherein each prong defines a retention space between said base portion and a portion of said prong which is most distal to said base portion, and wherein said retention space defined by each prong is located on a side of that prong which is distal to the other prong.

3. The carrying case of claim 2, wherein each prong has one convex curved side which is proximal to the other prong and one concave side which is distal to the other prong.

4. The carrying case of claim 2, wherein said prongs are L-shaped, each prong having one leg that extends outward from a side of said base portion and a second leg that extends away from the other prong.

5. The carrying case of claim 2, wherein said prongs extend away from said base portion at essentially equal and opposite oblique angles thereto.

6. The carrying case of claim 1, wherein said prongs are made stiffer than the majority of the remaining portions of said case.

7. The carrying case of claim 6, wherein inserts are sewn into said prongs to increase stiffness.

8. The carrying case of claim 1, wherein said strap has two ends and is affixed to said base portion at a point between those ends.

9. The carrying case of claim 8, wherein said strap is affixed to said base portion at a point which is closer to one end of said strap than the other.

10. The carrying case of claim 8, wherein a closure is located on each end of said strap.

11. The carrying case of claim 10, wherein said strap has two faces, with the two closures located on opposite faces of said strap.

12. The carrying case of claim 11, wherein said closures are corresponding male and female snaps.

13. The carrying case of claim 11, wherein said closures are corresponding pads of hook and loop closure material.

14. In a carrying case for a mobile telephone of the type having a base portion the improvement comprising:
two prongs extending from the base portion;
a strap extending from the base portion at a position between said prongs; and
a closure on at least one end of said strap.

15. The improvement of claim 14, wherein each prong defines a retention space between the base portion and a portion of said prong which is most distal to the base portion, and wherein said retention space defined by each prong is located on a side of that prong which is distal to the other prong.

16. The improvement of claim 15, wherein each prong has one convex curved side which is proximal to the other prong and one concave side which is distal to the other prong.

17. The improvement of claim 15, wherein said prongs are L-shaped, each prong having one leg that extends outward from a side of the base portion and a second leg that extends away from the other prong.

18. The improvement of claim 15, wherein said prongs extend away from the base portion at essentially equal and opposite oblique angles thereto.

19. The improvement of claim 14, wherein said prongs are made stiffer than the majority of the remaining portions of said case.

20. The improvement of claim 19, wherein inserts are sewn into said prongs to increase stiffness.

21. The improvement of claim 14, wherein said strap has two ends and is affixed to the base portion at a point between those ends.

22. The improvement of claim 21, wherein said strap is affixed to the base portion at a point which is closer to one end of said strap than the other.

23. The improvement of claim 21, wherein a closure is located on each end of said strap.

24. The improvement of claim 23, wherein said strap has two faces, with the two closures located on opposite faces of said strap.

25. The improvement of claim 14, wherein said closures are corresponding male and female snaps.

26. The improvement of claim 14, wherein said closures are corresponding pads of hook and loop closure material.

27. A cord organizer integral with a base portion of a carrying case for a mobile telephone, comprising:
two prongs extending from the base portion;
a strap extending from the base portion at a position between said prongs; and
a closure on at least one end of said strap.

28. The cord organizer of claim 27, wherein each prong defines a retention space between the base portion and a portion of said prong which is most distal to the base portion, and wherein said retention space defined by each prong is located on a side of that prong which is distal to the other prong.

29. The cord organizer of claim 28, wherein each prong has one convex curved side which is proximal to the other prong and one concave side which is distal to the other prong.

30. The cord organizer of claim 28, wherein said prongs are L-shaped, each prong having one leg that extends outward from a side of the base portion and a second leg that extends away from the other prong.

31. The cord organizer of claim 28, wherein said prongs extend away from the base portion at essentially equal and opposite oblique angles thereto.

32. The cord organizer of claim 27, wherein said prongs are made stiffer than the majority of the remaining portions of said case.

33. The cord organizer of claim 32, wherein inserts are sewn into said prongs to increase stiffness.

34. The cord organizer of claim 27, wherein said strap has two ends and is affixed to the base portion at a point between those ends.

35. The cord organizer of claim 34, wherein said strap is affixed to the base portion at a point which is closer to one end of said strap than the other.

36. The cord organizer of claim 34, wherein a closure is located on each end of said strap.

37. The cord organizer of claim 36, wherein said strap has two faces, with the two closures located on opposite faces of said strap.

38. The cord organizer of claim 27, wherein said closures are corresponding male and female snaps.

39. The cord organizer of claim 27, wherein said closures are corresponding pads of hook and loop closure material.
